(19) United States
(12) Patent Application Publication
(10) Pub. No.: US 2016/0021860 A1
(43) Pub. Date: Jan. 28, 2016

(54) Scissor jack tackle box system

(71) Applicant: Richard Fortney, Lost Creek, WV (US)

(72) Inventor: Richard Fortney, Lost Creek, WV (US)

(21) Appl. No.: 14/121,040

(22) Filed: Jul. 24, 2014

(51) Int. Cl. A01K 97/06

(52) U.S. Cl. CPC A01K 97/06

(57) ABSTRACT

The Scissor Jack Tackle Box System is a space saving scissor jack system that can hold numerous tackle boxes on shelves that are connected to a scissor jack on each side of the shelves and the tackle box. The pull strap is used to pull the scissor jack up with the tackle boxes and it makes it much easier to reach the bait and tackle inside the tackle boxes. This used for a better fishing experience and for competitive fishing.

### BACKGROUND OF THE INVENTION

(1) Field of the Invention

The Scissor Jack Tackle Box System is a system to be able to fishing bait much faster and easier using very little space as compared to tackle boxes used today.

(2) Description of the art including information disclosed under 37 CFR 1.97 & 1.98

The art described in the drawings of the design and utility function illustrate the unique ability of the Scissor Jack Tackle Box System be used in small spaces and we have found no other prior art that is similar to this invention.

### BRIEF SUMMARY OF THE INVENTION

The Scissor Jack Tackle Box System is fast and easy to use and takes up very little space. It used for competitive fishing and is very unique in the fact that it can be used in almost any small space area on a boat.

### BRIEF DESCRIPTION OF THE SEVERAL VIEWS OF THE DRAWINGS

There are 5 drawings in total that describe and illustrate the design and function of the Scissor Jack Tackle Box System. The tackle boxes are in broken lines and are for illustration purposes only because numerous types of tackle box designs can be used.

FIG. 1: is the ¾ view showing the scissor jack with the tackles boxes attached in fully upright position with the pull handle at the top of the jack.

FIG. 2: is the front view of the scissor jack with the tackles boxes attached in a fully upright position with the pull handle at the top of the jack.

FIG. 3: is the side view of the scissor jack with the tackles boxes attached in a fully upright position with the pull handle at the top of the jack.

FIG. 4: is the top view of the scissor jack system with tackle box removed from the frame.

FIG. 5: is the top view of the scissor jack system with the tackle box attached to the frame.

### DETAILED DESCRIPTION OF THE PREFERRED EMBODIMENT

The tackle boxes are in broken lines and are for illustration purposes only because numerous types of tackle box designs can be used.

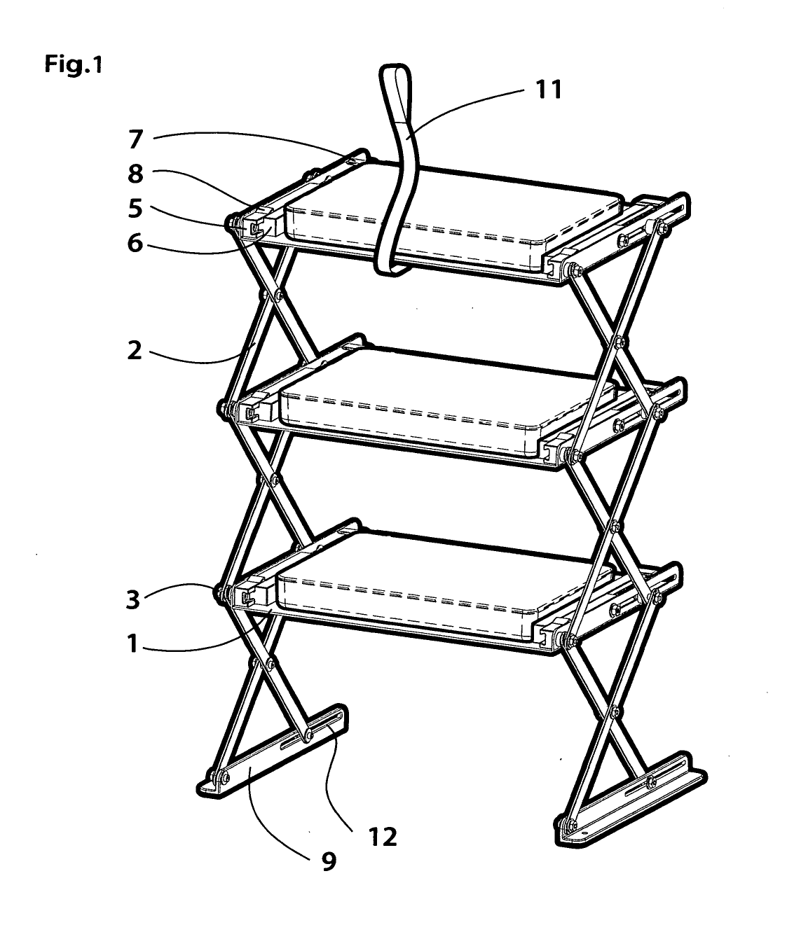

FIG. 1: In this ¾ view illustration #1 is the shelf tray area that holds the tackle box on top of it with #2 the scissor arm that is connected to the #3 common bolt assembly that connects the scissor arm assembly to the #5 the female box runner to #6 the male box runner that is connected to the tackle box in broken lines with #7 the runner stop tab that stops the tackle box from falling off the scissor rack with #8 the runner stop block with #9 the mounting foot bracket with #12 the scissor expansion slot that allows the jack to move upward and downward with restricted movement.

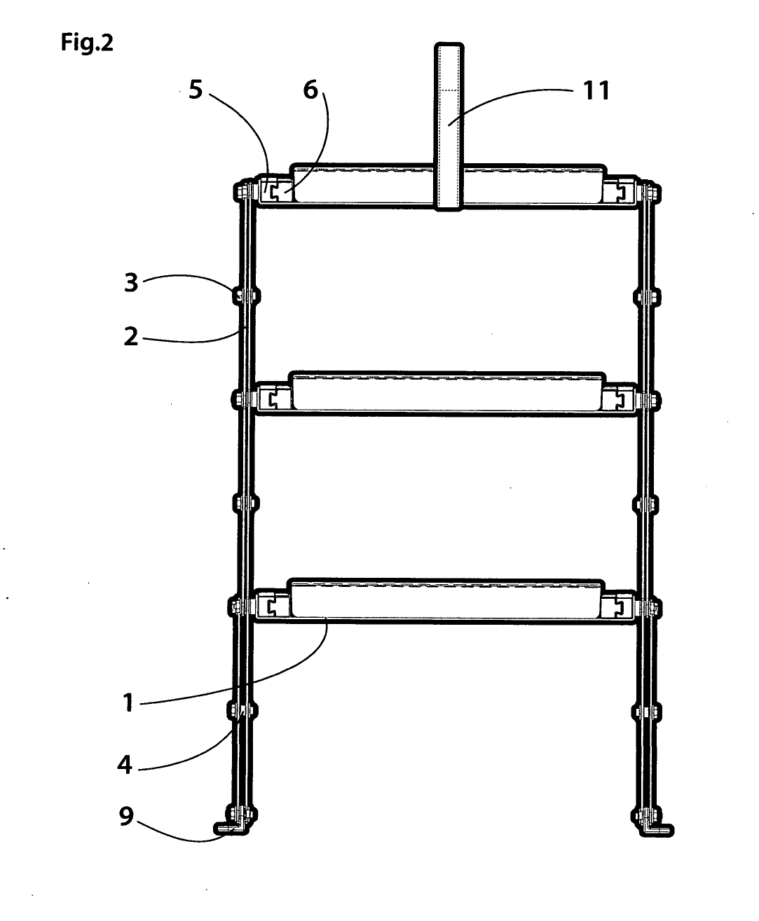

FIG. 2: In this front view illustration #1 is the shelf tray area that holds the tackle box on top of it with #2 the scissor arm that is connected to the #3 common bolt assembly that connects the scissor arm assembly to the #4 the arm spacer bushing that holds the jack in position as it moves upward and downward with #5 the female box runner to #6 the male box runner that is connected to the tackle box in broken lines with #9 the mounting foot bracket with #11 the pull strap that pulls the jack upward and downward.

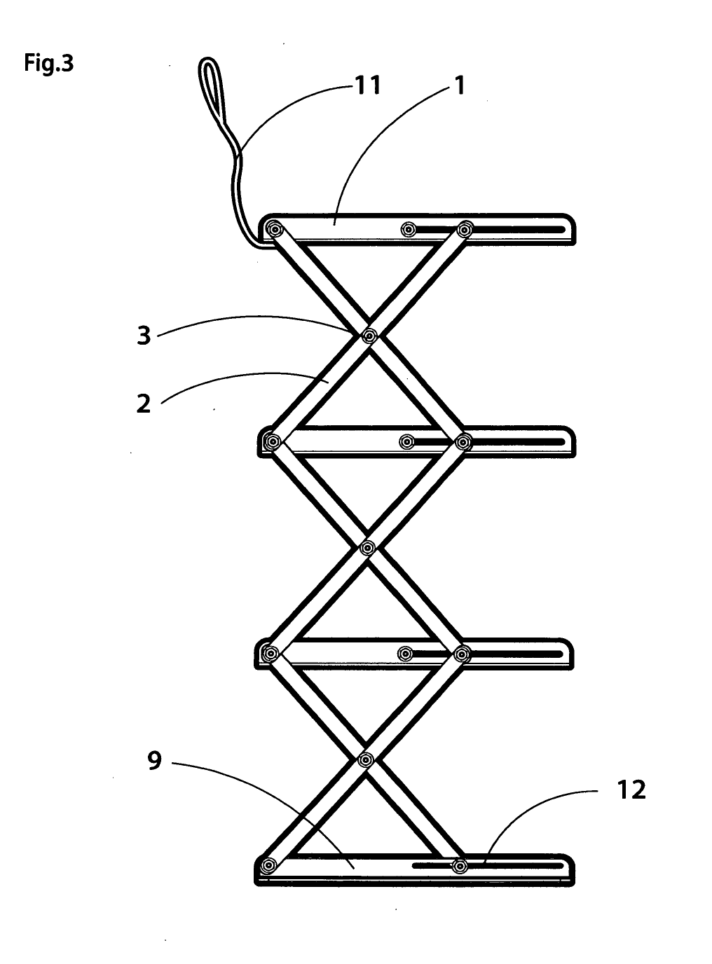

FIG. 3: In this side view illustration #1 is the shelf tray area that holds the tackle box on top of it with #2 the scissor arm that is connected to the #3 common bolt assembly that connects the scissor arm assembly to #9 the mounting foot bracket with #11 pull strap that pulls the jack upward and downward with #12 the scissor expansion slot that allows the jack to move upward and downward with restricted movement.

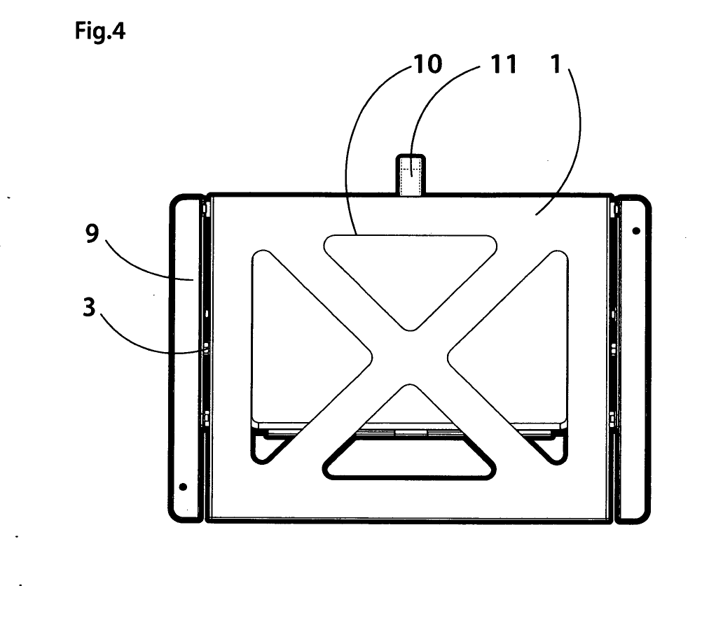

FIG. 4: In this top view illustration with the tackle box in broken lines not attached #1 is the shelf tray area that holds the tackle box on top of it with #3 the common bolt assembly that connects the scissor arm assembly to #9 the mounting foot bracket with #10 the weight reducing cutout to make the shelf more lightweight with #11 pull strap that pulls the jack upward and downward.

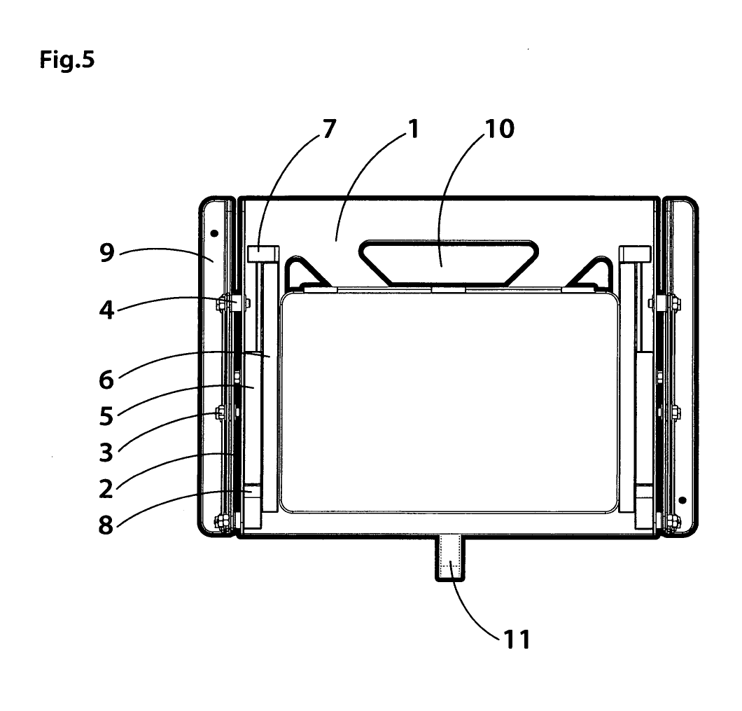

FIG. 5: In this top view illustration with the tackle box in broken lines attached #1 is the shelf tray area that holds the tackle box on top of it with #2 the scissor arm that is connected to the #3 common bolt assembly that connects the scissor arm assembly to the #4 the arm spacer bushing that holds the jack in position as it moves upward and downward with #5 the female box runner to #6 the male box runner that is connected to the tackle box in broken lines with #7 the runner stop tab that stops the tackle box from falling off the scissor rack with #8 the runner stop block with #9 the mounting foot bracket #10 the weight reducing cutout to make the shelf more lightweight with #11 pull strap that pulls the jack upward and downward.

### DETAILED DESCRIPTION OF THE INVENTION

The Scissor Jack Tackle Box system is a unique concept for competitive fishing anglers and for easier and faster access to fishing tackle and bait. It is designed with a scissor mechanism on each side of the shelf that holds the tackle box in place. The scissor jack has bushings that are pressure applied to allow the upward movement of the scissor portion and will hold it in place while in a full upright position. When pressure is applied to push the jack downward it moves in a fluid motion and stays in place because the pressure applied bushings. The shelves hold the tackle boxes in place and they also make the system stable so that it does not move back and forth. They hold it in place to move and a straight upward and downward motion. The shelf trays which are the shelves have a male and female box runner which connects to the scissor portion and connects to the tackle boxes which allow the boxes to move back and forth inside the shelf tray and are held in place once in position much the same way the bushings used for the scissor jack itself. All of this allows the system to be placed in a small space such as under or inside of a boat seat. Once the boat seat is lifted up you can grab the pull strap and pull the scissor jack upward and reveal the tackle boxes to grab the bait or fishing tackle much easier and faster.

What is claimed is:

1. A scissor jack tackle box system that is comprised of:
a shelf tray area that holds a tackle box on top of the shelf and inside of the two scissor portions on each side of the shelf;
a scissor arm that is connected to a common bolt assembly that connects the scissor arm assembly to the arm spacer bushing that holds the jack in position as it moves upward and downward;
a female box runner to connected to a male box runner where the male runner slides back and forth inside of the female box runner that is connected to the tackle box;
a runner stop tab that stops the tackle box from falling off the scissor rack with the runner stop block;
a mounting foot bracket that connects the main body of the scissor jack portion on each side of the shelves that can be bolted into any surface to hold it in position;
a weight reducing cutout to make the shelf tray more lightweight;
a pull strap that pulls the scissor jack upward and downward;
a scissor expansion slot built into the mounting foot bracket that allows the jack to move upward and downward with restricted movement within the slot with the bolt bushing that holds the scissor portion in place and moves back and forth within the slot.
